(19) United States
(12) Patent Application Publication
(10) Pub. No.: US 2015/0033720 A1
(43) Pub. Date: Feb. 5, 2015

(54) Hydraulic Motor Drive System and Method

(71) Applicant: Caterpillar Inc., Peoria, IL (US)

(72) Inventors: Edward Mate, Manhattan, IL (US); Zhangong Du, Naperville, IL (US); John Mount, Washington, IL (US)

(73) Assignee: Caterpillar Inc., Peoria, IL (US)

(21) Appl. No.: 13/958,885

(22) Filed: Aug. 5, 2013

(51) Int. Cl. F15B 13/04

(52) U.S. Cl. CPC F15B 13/0401
USPC 60/327; 60/494

(57) ABSTRACT

A hydraulic motor drive system is disclosed. The hydraulic motor drive system includes a pump, a flow control module fluidly coupled to a discharge of the pump via a first conduit, and a hydraulic motor fluidly coupled to the flow control module via a second conduit and a third conduit, and a controller operatively coupled to the flow control module. The controller is configured to operate the flow control module in a first mode, such that the flow control module blocks fluid communication between the pump and the hydraulic motor via the second conduit, and effects fluid communication between the pump and the hydraulic motor via the third conduit, and operate the flow control module in a second mode, such that the flow control module effects fluid communication between the pump and the hydraulic motor via the second conduit.

### TECHNICAL FIELD

This patent disclosure relates generally to hydraulic systems and, more particularly, to hydraulic motor drive systems.

### BACKGROUND

Hydraulic systems are known for converting fluid energy, for example, fluid pressure, into mechanical energy. Fluid power may be transferred from a hydraulic pump through fluid conduits to one or more hydraulic actuators. Hydraulic actuators may include hydraulic motors that convert fluid power into shaft rotational power, hydraulic cylinders that convert fluid power into translational motion, or the like.

Some hydraulic systems include hydraulic actuators subject to intermittent operation, which may allow the actuators to cool during idle periods to a temperature below the temperature of the hydraulic fluid supply. Then upon the next operating cycle, the relatively cool material of the hydraulic actuator may heat non-uniformly when exposed to the warmer hydraulic fluid, thus causing differential thermal expansion between portions of the hydraulic actuator. Such differential thermal expansion may result in diminished actuator performance or increased wear within the actuator.

U.S. Pat. No. 3,969,897 (hereinafter “the '897 patent), entitled “Temperature-Control Arrangement for a Pair of Hydraulic Motors,” describes means for equalizing temperature within a hydraulic system. According to the '897 patent, a first hydraulic pump coupled to a pair of counter-weight control jacks supplies a warming flow of hydraulic fluid to two other motors when the counter weight control jacks are not being actuated. However, when the first hydraulic pump is used to operate the pair of counter-weight control jacks, the warming flow to the other two motors is cut off to divert the fluid to the counter weight control jacks.

Accordingly, there is a need for an improved hydraulic motor drive system, and method of operating the same, that provides more operational flexibility to deliver hydraulic fluid for warming one hydraulic actuator independent of the operating states of other hydraulic actuators in the system.

### SUMMARY

In one aspect, the disclosure describes a hydraulic motor drive system. The hydraulic motor drive system includes a pump, a flow control module fluidly coupled to a discharge of the pump via a first conduit, and a hydraulic motor fluidly coupled to the flow control module via a second conduit and a third conduit, and a controller operatively coupled to the flow control module. The controller is configured to operate the flow control module in a first mode, such that the flow control module blocks fluid communication between the pump and the hydraulic motor via the second conduit, and effects fluid communication between the pump and the hydraulic motor via the third conduit, and operate the flow control module in a second mode, such that the flow control module effects fluid communication between the pump and the hydraulic motor via the second conduit.

In another aspect, the disclosure describes a machine. The machine includes a pump, a flow control module fluidly coupled to a discharge of the pump via a first conduit, a hydraulic motor fluidly coupled to the flow control module via a second conduit and a third conduit, and a controller operatively coupled to the flow control module. The controller is configured to operate the flow control module in a first mode, such that the flow control module blocks fluid communication between the pump and the hydraulic motor via the second conduit, and effects fluid communication between the pump and the hydraulic motor via the third conduit, and operate the flow control module in a second mode, such that the flow control module effects fluid communication between the pump and the hydraulic motor via the second conduit.

In yet another aspect, the disclosure describes a method of controlling a hydraulic motor system. The hydraulic motor system includes a pump, a flow control module fluidly coupled to a discharge of the pump via a first conduit, and a hydraulic motor fluidly coupled to the flow control module via a second conduit and a third conduit. The method includes adjusting the flow control module to a first mode, such that the flow control module blocks fluid communication between the pump and the hydraulic motor via the second conduit, and effects fluid communication between the pump and the hydraulic motor via the third conduit, and adjusting the flow control module to a second mode, such that the flow control module effects fluid communication between the pump and the hydraulic motor via the second conduit.

### BRIEF DESCRIPTION OF THE DRAWINGS

FIG. 1 is a perspective view of a machine, according to an aspect of the disclosure.

FIG. 2 is a schematic view of a hydraulic motor drive system, according to an aspect of the disclosure.

FIG. 3 is a schematic view of a hydraulic motor drive system, according to an aspect of the disclosure.

FIG. 4 is a schematic view of a hydraulic motor drive system, according to an aspect of the disclosure.

### DETAILED DESCRIPTION

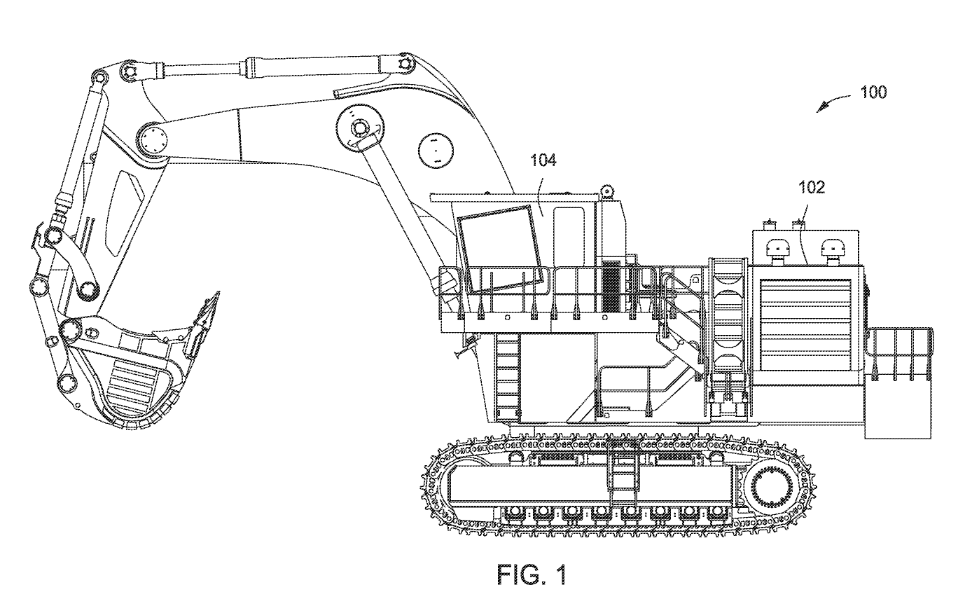

Referring now to the drawings, wherein like reference numbers refer to like elements, there is illustrated a machine including a hydraulic motor drive system. The machine can be any type of machine that performs an operation associated with an industry such as mining, construction, agriculture, transportation, stationary power generation, or any other industry known in the art. For example, the machine may be an off-highway truck, an earth-moving machine, such as a wheel loader, excavator, dump truck, backhoe, motor grader, material handler, or the like. Alternatively, the machine could be an on-road vehicle, such as, for example, a tour bus or a truck. The specific machine illustrated in FIG. 1 is a hydraulic shovel.

The machine 100 may be powered by an engine located within an engine enclosure 102. The engine may be a reciprocating internal combustion engine, such as a spark ignition engine or a compression ignition engine, a reciprocating external combustion engine, such as a Stirling cycle engine, a combustion turbine, an electric motor, combinations thereof, or any other engine known to persons having ordinary skill in the art. The engine may drive auxiliary components, such as, for example, alternators, fans, hydraulic pumps, refrigerant cycle compressors, or other auxiliary components known to persons having ordinary skill in the art. The auxiliary components may be coupled to the engine through a mechanical coupling, such as, for example, a shaft drive or a belt drive; a hydraulic coupling; an electrical coupling; combinations thereof; or other coupling known to persons having ordinary skill in the art.

The machine 100 may also include an operator cab 104 that provides control interfaces between a user and the machine 100. The operator cab 104 may be climate controlled by a heating system, an air conditioning system, or combinations thereof. A vapor refrigeration cycle for a cab air conditioning system may include a refrigerant compressor, an evaporator, and a condenser, such that at least the evaporator is in thermal communication with the operator cab 104. The vapor refrigeration cycle may be directly or indirectly coupled to the engine, as described above, to provide driving power for a refrigerant compressor.

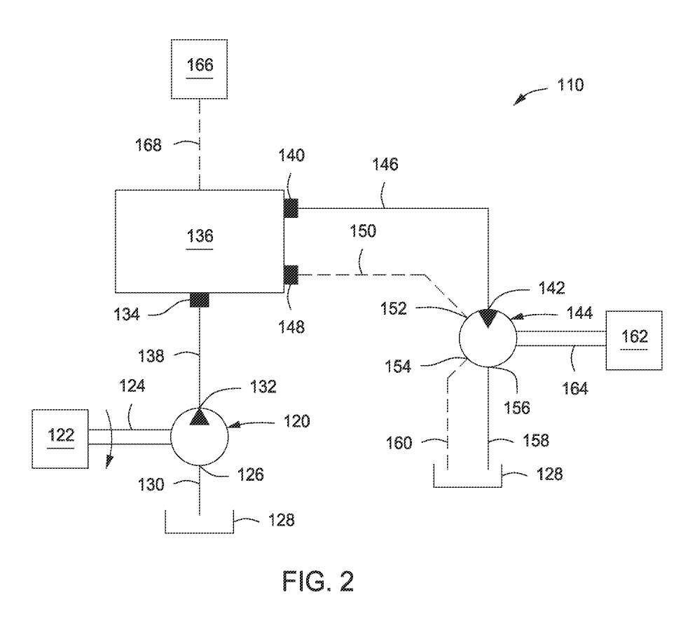

FIG. 2 is a schematic view of a hydraulic motor drive system 110, according to an aspect of the disclosure. In FIG. 2, a hydraulic pump 120 is operatively coupled to a prime mover 122 through a shaft 124. The prime mover 122 may be the engine of the machine 100, an auxiliary drive that derives power from the engine of the machine 100, or other source of mechanical driving power known to persons having ordinary skill in the art. The shaft 124 may transmit mechanical power from the prime mover 122 to the pump 120 through rotational motion, reciprocating motion, or combinations thereof. The pump 120 may be a fixed displacement pump, or alternatively a variable displacement pump.

An inlet 126 of the pump 120 is fluidly coupled to a hydraulic fluid reservoir 128 via an intake conduit 130. A discharge 132 of the pump 120 is fluidly coupled to an inlet 134 of a flow control module 136 via a first conduit 138. The flow control module 136 may include various flow control components such as valves, orifices, sensors, actuators, or other flow control components known to persons having ordinary skill in the art. The flow control components included in the flow control module 136 may be combined within a single module housing, or alternatively may be distributed throughout the hydraulic motor drive system 110.

A first outlet 140 of the flow control module 136 is fluidly coupled to a hydraulic drive inlet 142 of a hydraulic motor 144 via a second conduit 146. The hydraulic drive inlet 142 is in fluid communication with a drive circuit of the hydraulic motor 144 that converts hydraulic power into mechanical shaft power. The hydraulic motor 144 may be a linear motor, such as a hydraulic cylinder that produces linear shaft power, a rotary motor that produces rotating shaft power, or combinations thereof. A second outlet 148 of the flow control module 136 is fluidly coupled to the hydraulic motor 144 via a third conduit 150.

According to one aspect of the disclosure, the third conduit 150 is fluidly coupled to the hydraulic motor 144 via a warming inlet 152, where warming inlet 152 is in fluid communication with a warming circuit of the hydraulic motor 144. The warming circuit of the hydraulic motor 144 my pass through a housing of the hydraulic motor 144 from the warming inlet 152 to a warming outlet 154 and be distinct from the drive circuit of the hydraulic motor 144. Further, the warming circuit of the hydraulic motor 144 may be free from fluid communication with the drive circuit of the hydraulic motor 144 within the hydraulic motor 144. Alternatively, the warming circuit of the hydraulic motor 144 may pass through a housing of the hydraulic motor 144 and be in fluid communication with the drive circuit of the hydraulic motor 144, such that fluid that enters the warming inlet 152 may exit the hydraulic motor 144 via the warming outlet 154, a hydraulic drive outlet 156 that is in fluid communication with the drive circuit of the hydraulic motor 144, or combinations thereof. Thus, the warming outlet 154 may or may not be in fluid communication with the drive circuit of the hydraulic motor 144 within the hydraulic motor 144.

The hydraulic drive outlet 156 may be fluidly coupled to the hydraulic fluid reservoir 128 via a main return conduit 158, and the warming outlet 154 may be fluidly coupled to the hydraulic fluid reservoir 128 via a warming return conduit 160.

The hydraulic motor 144 may be coupled to a load 162 through a shaft 164. The load 162 could be an auxiliary component of the engine of the machine 100, such as, a refrigerant compressor, an alternator, or a fan, for example. The shaft 164 may transmit mechanical power from the hydraulic motor 144 to the load 162 through rotational motion, reciprocating motion, or combinations thereof.

The flow control module 136 may be operatively coupled to a controller 166 via one or more signal lines 168. The one or more signal lines 168 may convey actuating signals to the flow control module 136 through fluid communication, optical communication, electrical communication, or the like. It will be appreciated that the one or more signal lines 168 may also include a wireless electromagnetic coupling between the controller 166 and the flow control module 136. Thus, non-limiting examples of control signals from the controller 166 to the flow control module 136 include hydraulic signals, electrical signals, pneumatic signals, light signals, electromagnetic signals, or combinations thereof.

The controller 166 may control an operating mode of the flow control module 136. According to one aspect of the disclosure, the controller 166 is configured to operate the flow control module 136 in a first mode, such that the flow control module 136 blocks fluid communication between the pump 120 and the hydraulic motor 144 via the second conduit 146, and the flow control module 136 effects fluid communication between the pump 120 and the hydraulic motor 144 via the third conduit 150.

According to another aspect of the disclosure, the controller 166 is configured to operate the flow control module 136 in a second mode, such that the flow control module 136 effects fluid communication between the pump 120 and the hydraulic motor 144 via the second conduit 146. Under the second operating mode, the flow control module 136 may block fluid communication between the pump 120 and the hydraulic motor 144 via the third conduit 150, or alternatively, the flow control module 136 may effect fluid communication between the pump 120 and the hydraulic motor 144 via the third conduit 150.

According to yet another aspect of the disclosure, the controller 166 is configured to operate the flow control module 136 in a third mode, such that the flow control module 136 blocks fluid communication between the pump 120 and the hydraulic motor 144 via the second conduit 146, and the flow control module 136 blocks fluid communication between the pump 120 and the hydraulic motor 144 via the third conduit 150.

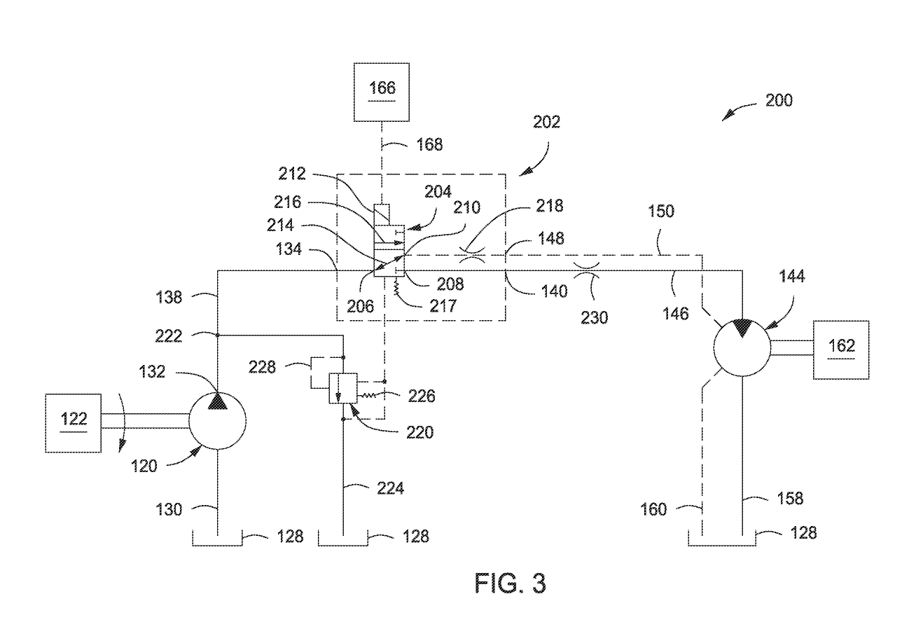

FIG. 3 is a schematic view of a hydraulic motor drive system 200, according to an aspect of the disclosure. The hydraulic motor drive system 200 includes a flow control module 202, and similar to the flow control module 136 in FIG. 2, the inlet 134 of flow control module 202 is fluidly coupled to the pump 120 via the first conduit 138, the first outlet 140 of the flow control module 202 is fluidly coupled to the hydraulic motor 144 via the second conduit 146, and the second outlet 148 of the flow control module 202 is fluidly coupled to the hydraulic motor 144 via the third conduit 150.

The flow control module 202 includes a blocking valve 204 having an inlet 206 that is fluidly coupled to the inlet 134 to the flow control module 202. Further, a first outlet 208 of the blocking valve 204 is fluidly coupled to the first outlet 140 of the flow control module 202, and a second outlet 210 of the blocking valve 204 is fluidly coupled to the second outlet 148 of the flow control module 202.

The controller 166 is operatively coupled to an actuator 212 of the blocking valve 204 via the one or more signal lines 168. The actuator 212 may include a hydraulic piston, a pneumatic piston, an electrical solenoid, a servomotor, combinations thereof, or any other valve actuator known to persons having ordinary skill in the art.

The controller 166 may cause the blocking valve 204 to operate in a first position corresponding to the first mode of operation of the flow control module 202. In the first position, the blocking valve 204 blocks fluid communication between the inlet 206 of the blocking valve 204 and the first outlet 208 of the blocking valve 204 via the blocking valve 204, and the blocking valve 204 effects fluid communication between the inlet 206 of the blocking valve 204 and the second outlet 210 of the blocking valve 204 via the valve passage 214. Accordingly, the first position of the blocking valve 204 effects fluid communication between the pump 120 and the hydraulic motor 144 via the third conduit 150, and blocks fluid communication between the pump 120 and the hydraulic motor 144 via the second conduit 146.

The controller 166 may also cause the blocking valve 204 to operate in a second position corresponding to a second mode of operation of the flow control module 202. In the second position, the blocking valve 204 effects fluid communication between the inlet 206 of the blocking valve 204 and the first outlet 208 of the blocking valve 204 via the valve passage 216, and the blocking valve 204 blocks fluid communication between the inlet 206 of the blocking valve 204 and the second outlet 210 of the blocking valve 204 via the blocking valve 204. Accordingly, the second position of the blocking valve 204 blocks fluid communication between the pump 120 and the hydraulic motor 144 via the third conduit 150, and effects fluid communication between the pump 120 and the hydraulic motor 144 via the second conduit 146.

The blocking valve 204 may include a resilient member 217 that biases the blocking valve 204 toward the first position. Further, the actuator 212, under the control of the controller 166, may act against a force of the resilient member 217 to bias the blocking valve toward the second position. Alternatively, the actuator 212 may be a double-acting actuator, such as an electric or hydraulic servomotor, for example, which is capable of varying a position of the blocking valve 204 in either a closing direction or an opening direction without a resilient member 217.

The flow control module 202 may include an orifice 218 disposed in the third conduit 150, which is configured to limit a flow of hydraulic fluid from the pump 120 to the hydraulic motor 144 via the third conduit 150 by imposing an additional fluid restriction to the third conduit 150. It will be appreciated that the orifice 218 may have a fixed geometry or a variable flow area.

Further, the hydraulic motor drive system 200 may include a relief valve 220 fluidly coupled to the discharge 132 of the pump 120, for example, at the node 222 along the first conduit 138, and fluidly coupled to the hydraulic fluid reservoir 128 via the return conduit 224. A resilient member 226 may bias the relief valve 220 toward a position that blocks flow through the relief valve 220. However, pressure from a pilot conduit 228 may act against the force of the resilient member 226 to bias the relief valve 220 toward a position that effects flow through the relief valve. Thus, the relief valve 220 may act to relieve pressure in the first conduit 138 when a pressure in the first conduit 138 exceeds a threshold value. It will be appreciated that the relief valve 220 may toggle between closed and open positions, or alternatively may effect a flow through the return conduit 224 that is proportional to the pressure in the pilot conduit 228.

According to an aspect of the disclosure, the hydraulic motor drive system 200 may include an orifice 230 disposed in the second conduit 146, such that a flow area of the orifice 230 is smaller than a flow area of the second conduit 146. It will be appreciated that the orifice 230 may have a fixed geometry or a variable flow area.

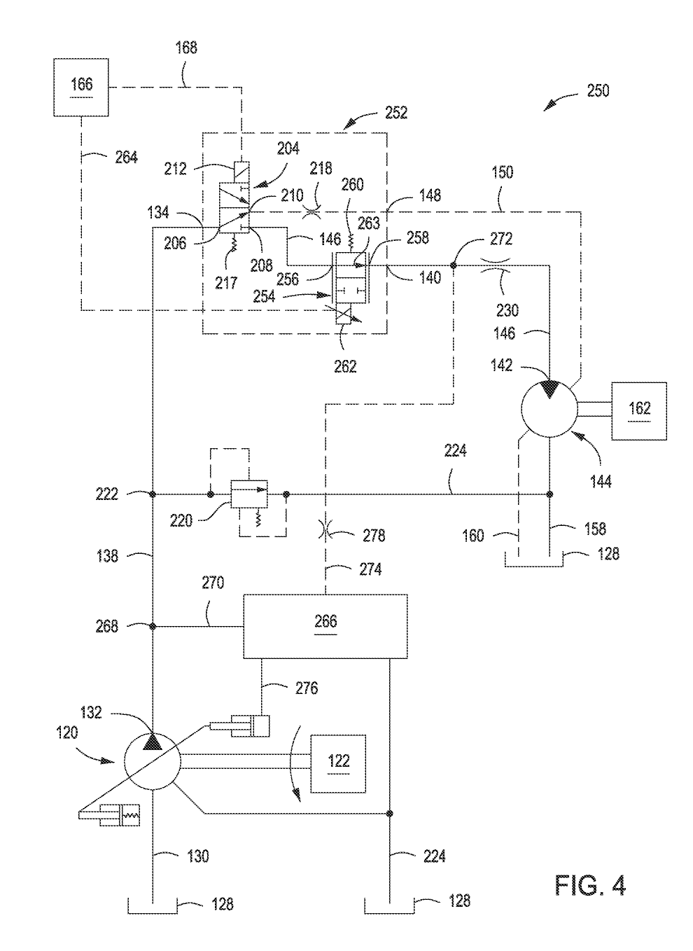

FIG. 4 is a schematic view of a hydraulic motor drive system 250, according to an aspect of the disclosure. The hydraulic motor drive system 250 includes a flow control module 252, and similar to the flow control module 136 in FIG. 2, the inlet 134 of flow control module 252 is fluidly coupled to the pump 120 via the first conduit 138, the first outlet 140 of the flow control module 252 is fluidly coupled to the hydraulic motor 144 via the second conduit 146, and the second outlet 148 of the flow control module 252 is fluidly coupled to the hydraulic motor 144 via the third conduit 150.

Similar to the flow control module 202 in FIG. 3, the flow control module 252 includes a blocking valve 204 having an inlet 206 that is fluidly coupled to the inlet 134 of the flow control module 252. Further, a first outlet 208 of the blocking valve 204 may be fluidly coupled to the first outlet 140 of the flow control module 252, and a second outlet 210 of the blocking valve 204 is fluidly coupled to the second outlet 148 of the flow control module 252.

The flow control module 252 further includes a control valve 254 disposed along the second conduit 146. The control valve 254 has an inlet 256 fluidly coupled to the second conduit 146 downstream of the blocking valve 204 in a direction of hydraulic fluid flow from the blocking valve 204 toward the hydraulic motor 144. An outlet 258 of the control valve 254 is fluidly coupled to the second conduit 146 downstream of the inlet 256 in the direction of hydraulic fluid flow from the blocking valve 204 toward the hydraulic motor 144.

The control valve 254 may have a resilient member 260 that biases the control valve toward an open position. The control valve 254 may also have an actuator 262 that is operatively coupled to the controller 166 via at least one signal line 264, such that the actuator 262 may generate a force in opposition to a force of the resilient member 260 to bias the control valve 254 toward a closed position that blocks fluid communication between the inlet 256 of the control valve 254 and the outlet 258 of the control valve 254 via a valve passage 263. Alternatively, the actuator 262 may be a double-acting actuator capable of varying a position of the control valve 254 in either a closing direction or an opening direction without a resilient member 260.

According to an aspect of the disclosure, a force generated by the actuator 262 against the force of the resilient member 260 may be proportional to a signal magnitude, or other signal characteristic known to persons having ordinary skill in the art, communicated from the controller 166 to the actuator 262 via the at least one signal line 264, such that the control valve 254 may effect a continuous or discrete spectrum of flow areas therethrough. Accordingly, the control valve 254 may vary the hydraulic fluid flow to the hydraulic motor 144 over a continuous or discrete spectrum of flow rates when the blocking valve 204 is located in an open position.

According to another aspect of the disclosure, the control valve 254 may be capable of blocking fluid communication between the blocking valve 204 and the hydraulic motor 144. Accordingly, the controller 166 may cause the flow control module 252 to operate in the third mode, which blocks fluid communication between the flow control module 252 and the hydraulic motor 144 through both the second conduit 146 and the third conduit 150, by actuating the blocking valve 204 to its second position and actuating the control valve 254 to its closed position. Alternatively, it will also be appreciated that the control valve 254 may be configured to have a minimum flow area greater than zero, such that the control valve 254 is not capable of completely blocking fluid communication between the blocking valve 204 and the hydraulic motor 144.

The pump 120 of the hydraulic motor drive system 250 may have a variable displacement that is controlled by a pump controller 266. The pump controller 266 may effect load-sensing control of the pump 120 displacement based on a comparison of the pressure near the discharge 132 of the pump 120 and a pressure near the inlet 142 of the hydraulic motor 144. For example, the pump controller 266 may sense pressure in the first conduit 138 at node 268 via pilot conduit 270, and sense pressure in the second conduit 146 at node 272 via pilot conduit 274.

Then based on a comparison of the pressure at node 268 and at node 272, the pump controller 266 delivers a control signal to the pump 120 via at least one signal line 276. According to one aspect of the disclosure, the at least one signal line 276 includes a hydraulic conduit that delivers a signal pressure from the pump controller 266 to the pump 120 that adjusts a displacement of the pump 120. However, it will be appreciated that the at least one signal line 276 could communicate a fluid signal, an electrical signal, an electromagnetic signal, or combinations thereof to the pump 120 to control the displacement thereof.

The pilot conduit 274 may include an orifice 278 disposed therein, such that the orifice 278 has a flow area that is smaller than a flow area of the pilot conduit 274. It will be appreciated that the orifice 278 may have a fixed geometry or a variable flow area.

The orifice 230 may be disposed in the second conduit 146 downstream of the node 272 in the direction of hydraulic flow from the control valve 254 to the hydraulic motor 144. Alternatively, the orifice 230 may be disposed in the second conduit 146 upstream of the node 272 in the direction of hydraulic flow from the control valve 254 to the hydraulic motor 144.

### INDUSTRIAL APPLICABILITY

The disclosure is universally applicable to any machine with a hydraulic system having an actuator that may operate intermittently.

According to one aspect of the disclosure, and particularly as shown in FIGS. 3 and 4, the load 162 coupled to the hydraulic motor 144 is a refrigerant compressor for an air-conditioning system of the machine 100. As a default state, the hydraulic motor 144 coupled to the refrigerant compressor may remain idle until the operator applies a control input to the controller 166 initiating operation of the refrigerant compressor. Alternatively, the controller 166 may apply hydraulic power to the hydraulic motor 144 to drive the refrigerant compressor based on a temperature measured in the operator cab 104 of the machine 100. Thus, the hydraulic motor 144 may cycle through periods of idle and operational states during use of the machine 100.

The controller 166 may vary the operational state of the hydraulic motor 144 by actuating the position of the blocking valve 204, for example, which varies the state of fluid communication between the pump 120 and the hydraulic motor 144, as discussed above. At the same time, operation of the blocking valve 204 may also vary the state fluid communication between the hydraulic motor 144 and a source of hydraulic fluid to warm the hydraulic motor when not being used to drive the refrigerant compressor. Thus, isolating the hydraulic motor 144 from the pump 120 via the blocking valve 204 may automatically apply a flow of warming fluid to a housing of the hydraulic motor 144, a drive circuit of the hydraulic motor 144, or combinations thereof, via the blocking valve 204.

The flow of warming fluid through the hydraulic motor 144 may help to maintain material temperatures of the hydraulic motor 144 near the temperature of the fluid in the hydraulic fluid reservoir 128 while the hydraulic motor 144 is idle. In turn, differential thermal expansion within the hydraulic motor 144 may be diminished or eliminated upon the next operational cycle of driving the refrigerant compressor with the hydraulic motor 144.

According to another aspect of the disclosure, the load 162 may be an engine cooling fan of the machine 100. While the machine 100 performs a water fording operation, which may expose the engine cooling fan to water, it may be desirable to either slow a rotational speed of fan operation or completely stop the operation of the fan.

The machine 100 operator may provide a control input to the controller 166 triggering a water fording operational mode, or the controller 166 may sense a water fording operation and trigger a water fording operational mode. According to the flow control module 202 in FIG. 3, for example, triggering the water fording operational mode may cause the blocking valve 204 to switch from the second position to the first position, thereby uncoupling the hydraulic motor 144 drive circuit from the pump 120 via the second conduit 146, but at the same time initiating a warming flow of hydraulic fluid from the pump 120 to the hydraulic motor 144 via the third conduit 150.

Alternatively, according to the flow control module 252 in FIG. 4, the blocking valve 204 may remain in the second position during a water fording operational mode, thereby effecting fluid communication between the pump 120 and the hydraulic motor 144 via the second conduit 146, but throttle the supply of hydraulic fluid to the hydraulic motor 144 by partially closing the control valve 254 to reduce a speed of rotation of the fan. Hence, an appropriate control signal to the actuator 262 of the control valve 254 may establish a sufficiently reduced operating speed of the fan during the water fording operation to avoid damage to the fan in contact with the water.

It will be appreciated that the hydraulic motor drive systems described herein may provide particular advantages in arctic environments where the machine 100 is exposed to low ambient temperatures, and the hydraulic motor 144 may be subject to especially rapid cooling during idle periods. Further, a warming flow through the third conduit 150 may be particularly helpful to gradually warm the hydraulic motor 144 from a cold starting state, where both the hydraulic motor 144 and the fluid in the hydraulic fluid reservoir 128 are both near ambient temperature.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

We claim:

1. A hydraulic motor drive system, comprising:
a pump;
a flow control module fluidly coupled to a discharge of the pump via a first conduit;
a hydraulic motor fluidly coupled to the flow control module via a second conduit and a third conduit; and
a controller operatively coupled to the flow control module, the controller being configured to
operate the flow control module in a first mode, such that the flow control module blocks fluid communication between the pump and the hydraulic motor via the second conduit, and effects fluid communication between the pump and the hydraulic motor via the third conduit, and
operate the flow control module in a second mode, such that the flow control module effects fluid communication between the pump and the hydraulic motor via the second conduit.

2. The hydraulic motor drive system of claim 1, wherein the second mode of the flow control module blocks fluid communication between the pump and the hydraulic motor via the third conduit.

3. The hydraulic motor drive system of claim 1, wherein the second mode of the flow control module effects fluid communication between the pump and the hydraulic motor via the third conduit.

4. The hydraulic motor drive system of claim 1, wherein the second conduit is fluidly coupled to a drive circuit of the hydraulic motor, and the third conduit is fluidly coupled to a warming circuit of the hydraulic motor that is distinct from the drive circuit of the hydraulic motor.

5. The hydraulic motor drive system of claim 1, wherein both the second conduit and the third conduit are fluidly coupled to a drive circuit of the hydraulic motor.

6. The hydraulic motor drive system of claim 1, wherein
the flow control module includes a blocking valve, an inlet of the blocking valve being fluidly coupled to the pump via the first conduit, a first outlet of the blocking valve being fluidly coupled to the hydraulic motor via the second conduit,
a first position of the blocking valve corresponds to the first mode of the flow control module, such that the first position of the blocking valve blocks fluid communication between the first conduit and the second conduit via the blocking valve, and
a second position of the blocking valve corresponds to the second mode of the flow control module, such that the second position of the blocking valve effects fluid communication between the first conduit and the second conduit via the blocking valve.

7. The hydraulic motor drive system of claim 6, wherein
a second outlet of the blocking valve is fluidly coupled to the hydraulic motor via the third conduit,
the first position of the blocking valve effects fluid communication between the first conduit and the third conduit via the blocking valve, and
the second position of the blocking valve blocks fluid communication between the first conduit and the third conduit via the blocking valve.

8. The hydraulic motor drive system of claim 6, further comprising a motor control valve disposed in the second conduit between the flow control module and the hydraulic motor, wherein
a first position of the motor control valve effects fluid communication between the flow control module and the hydraulic motor via the second conduit, and
a second position of the motor control valve blocks fluid communication between the flow control module and the hydraulic motor via the second conduit.

9. The hydraulic motor drive system of claim 8, wherein the motor control valve is a proportional control valve.

10. The hydraulic motor drive system of claim 1, wherein the controller is further configured to operate the flow control module in a third mode, such that the third mode of the flow control module blocks fluid communication between the pump and the hydraulic motor via the second conduit, and blocks fluid communication between the pump and the hydraulic motor via the third conduit.

11. The hydraulic motor drive system of claim 1, wherein an output shaft of the hydraulic motor is coupled to an input shaft of at least one of a refrigerant compressor and a fan.

12. The hydraulic motor drive system of claim 1, wherein an output shaft of the hydraulic motor is coupled to an input shaft of a refrigerant compressor, and the second conduit includes an orifice disposed therein, the orifice having a flow area that is smaller than a flow area of the second conduit.

13. A machine, comprising:
a pump;
a flow control module fluidly coupled to a discharge of the pump via a first conduit;
a hydraulic motor fluidly coupled to the flow control module via a second conduit and a third conduit; and
a controller operatively coupled to the flow control module, wherein the controller is configured to
operate the flow control module in a first mode, such that the flow control module blocks fluid communication between the pump and the hydraulic motor via the second conduit, and effects fluid communication between the pump and the hydraulic motor via the third conduit, and
operate the flow control module in a second mode, such that the flow control module effects fluid communication between the pump and the hydraulic motor via the second conduit.

14. The machine of claim 13, wherein the machine is a hydraulic shovel.

15. The machine of claim 13, wherein the machine is an on-road vehicle.

16. The machine of claim 13, wherein an output shaft of the hydraulic motor is coupled to an input shaft of at least one of a refrigerant compressor and a fan.

17. A method of controlling a hydraulic motor system, the hydraulic motor system including
a pump,
a flow control module fluidly coupled to a discharge of the pump via a first conduit, and
a hydraulic motor fluidly coupled to the flow control module via a second conduit and a third conduit, the method comprising:
adjusting the flow control module to a first mode, such that the flow control module blocks fluid communication between the pump and the hydraulic motor via the second conduit, and
effects fluid communication between the pump and the hydraulic motor via the third conduit; and
adjusting the flow control module to a second mode, such that the flow control module effects fluid communication between the pump and the hydraulic motor via the second conduit.

18. The method of claim 17, wherein the second mode of the flow control module blocks fluid communication between the pump and the hydraulic motor via the third conduit.

19. The method of claim 17, wherein the second mode of the flow control module effects fluid communication between the pump and the hydraulic motor via the third conduit.

20. The method of claim 17, further comprising adjusting the flow control module to a third mode, such that the flow control module blocks fluid communication between the pump and the hydraulic motor via the second conduit, and blocks fluid communication between the pump and the hydraulic motor via the third conduit.
